(19) United States
(12) Patent Application Publication
(10) Pub. No.: US 2012/0123893 A1
(43) Pub. Date: May 17, 2012

(54) Device, System, And Method For Trading Units Of Unique Valuable Assets

(75) Inventors: Anat Levin, Tel Aviv (IL); Shmuel Litvak, Tel Aviv (IL)

(73) Assignee: SPLITART S.A., Foetz (LU)

(21) Appl. No.: 13/384,380

(22) PCT Filed: Jul. 21, 2010
(86) PCT No.: PCT/IB10/53323

§ 371 Date: Jan. 17, 2012

(51) Int. Cl. G06Q 30/08

(52) U.S. Cl. 705/26.3

(57) ABSTRACT

Device, system, and method for trading units of Unique Valuable Assets (UVAs). For example, a method for securitizing a Unique Valuable Asset (UVA) may include: transferring custody and ownership in the UVA from a settling owner of the UVA to a fiduciary entity; issuing by the fiduciary entity a plurality of tradable UVA certificates which correspond to portions of ownership rights in the UVA; electronically selling by the fiduciary entity one or more of the tradable UVA certificates, through an auction, to one or more purchasers; and transferring from the fiduciary entity to the settling owner at least some of monetary consideration received by the fiduciary entity from said one or more purchasers of tradable UVA certificates.

### FIELD

Some embodiments are related to the field of investment and trading.

### BACKGROUND

A Unique Valuable Asset (UVA) may include, for example, a painting, a sculpture, or other unique artwork. An owner of a UVA may use one or more tools or mechanisms in order to sell the UVA to a purchaser. For example, the owner may advertise (e.g., in newspapers or on the Internet) that the UVA is for sale; the owner may utilize an auction house (e.g., Sotheby's or Christie's) to conduct a live auction for the UVA; or the owner may utilize a virtual auction web-site (e.g., eBay) to conduct an online auction for the UVA.

Some UVAs may be extremely expensive, and may be priced at millions of dollars. It may be difficult for an owner to sell an expensive UVA.

### SUMMARY

Some embodiments include, for example, devices, systems, and methods of trading units of Unique Valuable Assets (UVAs).

In some embodiments, for example, a method for securitizing a Unique Valuable Asset (UVA) may include: transferring custody and ownership in the UVA from a settling owner of the UVA to a fiduciary entity; issuing by the fiduciary entity a plurality of tradable UVA certificates which correspond to portions of ownership rights in the UVA; electronically selling by the fiduciary entity one or more of the tradable UVA certificates, through an online or electronic auction, to one or more purchasers; and transferring from the fiduciary entity to the settling owner at least some of monetary consideration received by the fiduciary entity from said one or more purchasers of tradable UVA certificates.

In some embodiments, the method may include: receiving from a first user a sale order offering to sell a first number of the tradable UVA certificates owned by the first user, for a particular asking price per UVA certificate.

In some embodiments, the method may include: receiving from a second user a purchase order offering to purchase a particular number of the tradable UVA certificates, for a particular bidding price per UVA certificate.

In some embodiments, the method may include: if (a) the first number of tradable UVA certificates offered to be sold by the first user is greater than or equal to the second number of tradable UVA certificates offered to be purchased by the second user, and (b) the asking price per UVA certificate is smaller than or equal to the bidding price per UVA certificate, then: transferring ownership in the first number of tradable UVA certificates from the first user to the second user; transferring from the second user to the first user a monetary equivalent of: the first number of tradable UVA certificates multiplied by the bidding price per UVA certificate.

In some embodiments, the method may include: hiding from the first user the identity of the second user; and hiding from the second user the identity of the first user.

In some embodiments, the method may include: determining a current price-quote for the tradable UVA certificates corresponding to said UVA.

In some embodiments, the method may include: generating a self-refreshing electronic display of said price-quote of the tradable UVA certificates corresponding to said UVA.

In some embodiments, the method may include: prior to issuing said tradable units, transferring said UVA to custody at a custodian on behalf of the fiduciary entity.

In some embodiments, the method may include: if all the tradable UVA certificates corresponding to said UVA are held by a single entity, then: (a) delisting the tradable UVA certificates from further trading; (b) terminating fiduciary duties of the fiduciary entity; and (c) transferring ownership and custody in said UVA to said single entity.

In some embodiments, said UVA may include an asset selected from the group consisting of: a painting, a sculpture, a photograph, an artwork, a diamond, a jewel.

In some embodiments, a system for securitizing a Unique Valuable Asset (UVA) may include: means for transferring custody and ownership in the UVA from a settling owner of the UVA to a fiduciary entity; means for issuing by the fiduciary entity a plurality of tradable UVA certificates which correspond to portions of ownership rights in the UVA; means for electronically selling by the fiduciary entity one or more of the tradable UVA certificates, through an online or electronic auction, to one or more purchasers; and means for transferring from the fiduciary entity to the settling owner at least some of monetary consideration received by the fiduciary entity from said one or more purchasers of tradable UVA certificates.

In some embodiments, the system may include: means for receiving from a first user a sale order offering to sell a first number of the tradable UVA certificates owned by the first user, for a particular asking price per UVA certificate.

In some embodiments, the system may include: means for receiving from a second user a purchase order offering to purchase a particular number of the tradable UVA certificates, for a particular bidding price per UVA certificate.

In some embodiments, the system may include: means to check if (a) the first number of tradable UVA certificates offered to be sold by the first user is greater than or equal to the second number of tradable UVA certificates offered to be purchased by the second user, and (b) the asking price per UVA certificate is smaller than or equal to the bidding price per UVA certificate, and if the check result is positive, then: means for transferring ownership in the first number of tradable UVA certificates from the first user to the second user; means for transferring from the second user to the first user a monetary equivalent of: the first number of tradable UVA certificates multiplied by the bidding price per UVA certificate.

In some embodiments, the system may include: means for hiding from the first user the identity of the second user; and means for hiding from the second user the identity of the first user.

In some embodiments, the system may include: means for determining a current price-quote for the tradable UVA certificates corresponding to said UVA.

In some embodiments, the system may include: means for generating a self-refreshing electronic display of said price-quote of the tradable UVA certificates corresponding to said UVA.

In some embodiments, the system may include: means for, prior to issuing said tradable units, transferring said UVA to custody at a custodian on behalf of the fiduciary entity.

In some embodiments, the system may include: means to check if all the tradable UVA certificates corresponding to said UVA are held by a single entity, and if the check result is positive, then: (a) means for delisting the tradable UVA certificates from further trading; (b) means for terminating fiduciary duties of the fiduciary entity; and (c) means for transferring ownership and custody in said UVA to said single entity.

In some embodiments, said UVA may include an asset selected from the group consisting of: a painting, a sculpture, a photograph, an artwork, a diamond, a jewel.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic flow-chart of a method of handling a Unique Valuable Asset (UVA) and trading its respective units, in accordance with some demonstrative embodiments.

FIG. 3 is a schematic block diagram illustration of a system in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The terms “Unique Valuable Asset” or “UVA” as used herein include, for example, a painting, a photograph, a sculpture, a statue, a work of art, an artwork, a piece of art, a unique piece of art, a non-unique or semi-unique piece of art (e.g., a numbered lithograph), an ornamental object or item or article, a jewel, a jewelry, a gemstone, an item that includes one or more precious or semi-precious stones, rare items, a one-of-a-kind item, memorabilia, vintage items, an item which does not have duplicates or replicas, a singular item, an item valued significantly more than other items of its types, a portable item, or the like. In some embodiments, a UVA may include only a portable item, and may exclude a non-tangible item, and may exclude real estate property.

The term “unit” or the term “certificate” as used herein includes, for example, a part, a portion, a fraction, or a percentage of a UVA, of a nominal representation of a UVA, of a nominal equivalent of a UVA, a liquidated UVA, a liquidated equivalent of a UVA, a liquidated or nominal equivalent of one or more legal rights (e.g., ownership) in the UVA, or the like. In some embodiments, a “unit” may include, for example, a share, a stock, a legal instrument, an option, a security, a derivative, a bond, a financial instrument, a monetary instrument, a physical or virtual or financial representation of ownership, a right, a bundle of rights, a secured or non-secured instrument, or the like.

In some embodiments, the entire 100 percent interest in a tangible UVA may be converted into trade-able UVA Units or UVA Certificates which may be offered to the public for purchase in an auction, as detailed herein. In other embodiments, an issuer of UVA Certificates (e.g., a Settler who owns the tangible immediately prior to such securitization process) may choose to offer to the public only a portion of the entire 100 percent interest in the tangible UVA, for example, only 90 percent, only 75 percent, only 66 percent, only 51 percent, only 50 percent, only 49 percent, only 25 percent, or other portions, while retaining its ownership interest in the remaining non-issued portion. Accordingly, although portion of the discussion herein may relate, for demonstrative purposed, to issuance of UVA Certificates or Units which correspond to the entire interest in the UVA, some embodiments may similarly include the issuance of UVA Certificates or Units which correspond to less than 100 percent of the interest in the UVA.

The term “electronic platform” as used herein includes, for example, an electronic system able to receive and execute commands from users for investing in UVA unit(s), trading UVA unit(s), or performing other suitable operations with regard to UVA unit(s). The electronic platform may be implemented, for example, using an Internet platform, using a World Wide Web platform, using one or more web-sites, using a virtual platform, using client/server architecture, using publisher/subscriber architecture, using Peer to Peer (P2) architecture, using centralized or partially centralized architecture, using distributed or partially distributed architecture, or other suitable architectures. In some embodiments, the electronic platform may include, or may be associated with, one or more entities, modules or sub-systems, for example, an art marketplace, brokers, affiliates, processing bank(s), and/or other entities, modules or sub-systems (e.g., as described herein).

Some embodiments may include, for example, an electronic platform or an online platform or an offline platform for trading of units of UVAs and/or for investing in units of UVAs.

In some embodiments, for example, an artist or creator or owner of a UVA may approach an appraiser (e.g., directly, or indirectly through an electronic platform), who may appraise the UVA and/or may verify the authenticity of the UVA. The appraiser may include one or more qualified specialists related to the relevant field (e.g., art specialists), and may perform a due diligence process regarding the UVA. The appraiser may determine an initial price associated with the UVA. The authenticated UVA may be stored a at a suitable storage facility, for example, to preserve the UVA in a safe and secure manner. The storage facility may include, for example, a gallery, a warehouse, a safe, a vault, a museum, a building, a secured area, a guarded area, a safe deposit box, a storage facility that is generally open to the public or that generally exhibits the UVA to visitors (e.g., a gallery), a storage facility that is not open to the public or that does not exhibit the UVA to visitors (e.g., a vault), or the like.

Once the UVA is appraised and stored, a units issuance may be performed such that the UVA is transformed from a tangible asset into a nominal asset, and a nominal representation or equivalent of the UVA is divided into units which may be traded among users. The issuance process may be performed using the electronic platform. For example, N units may be issued for a particular UVA, and each unit may correspond to 1/N of the ownership rights in the UVA, wherein N is a positive number. In some embodiments, the issued units may correspond to the entire right of ownership in the UVA; in other embodiments, the issued units may correspond to a portion of the right of ownership in the UVA (e.g., to 60 percent of the right of ownership in the UVA). For example, if the entire right of ownership in the UVA is issued, then each unit may be associated with an initial unit price, calculated by dividing the appraised value of the UVA by the number of issued units (N). Other suitable methods or calculations may be used for determining a UVA unit price, optionally taking into account maximum prices, minimum prices, or other parameters.

In some embodiments, the electronic platform may include a pre-trading arena or a pre-issuance arena in which new UVA units are introduced for a pre-defined time period to the general public. For example, if the demand for such new UVA units is significantly low, or is smaller than a pre-defined threshold, then the new UVA units may not be issued and may not become available to the general public, or a pre-planned issuance of UVA units may be cancelled or withdrawn. In contrast, an issuance that exceeds the threshold may be traded on the electronic platform.

The issued units may be offered for sale to the general public. This may be performed using one or more web-sites, using a dedicated software application, using suitable hardware components (e.g., servers and/or terminals), and/or using other implementation of electronic platform or online platform. For example, a first user may electronically purchase one or more UVA units by electronically paying the corresponding price; the electronic platform collects the payment and/or price from the purchaser, transfers the payment and/or price to the seller (optionally after deducting a commission), and registers the purchaser as the owner of the one or more purchased units.

The user who purchased the unit(s) may further trade the unit(s), for example, by selling the unit(s) to one or more other users through the electronic platform. The electronic platform may be adapted to receive and to execute, for example, “buy” orders, “sell” orders, or other trading orders or operations (e.g., display of UVA unit prices or details of recent transactions) with regard to UVA units.

In some embodiments, issuance of new UVA units, trading of UVA units, and/or the operation of the electronic platform may be in accordance with pre-defined rules and regulations.

Once UVA units are issued, various parameters, for example, market activity and market forces (e.g., supply and demand), may influence or may determine the price of UVA units.

In some embodiments, the electronic platform may be adapted to handle a purchase of substantially 100 percent of the units of a UVA. For example, such UVA may be removed from further unit trading through the electronic platform; and the owner of the UVA units may exercise his legal rights as a sole owner of the UVA, e.g., by taking possession of the original UVA stored at the storage facility.

In some embodiments, the electronic platform may determine that a significantly low volume of units are traded with respect to a particular UVA. As a result, the UVA may be removed from further unit trading through the electronic platform, in accordance with the pre-defined rules and regulations.

In some embodiments, the electronic platform may include, or may be associated with, chat-room and message boards related to trading of UVA units; as well as indices to track prices of UVA units or groups thereof (e.g., a paintings index, a sculptures index).

In some embodiments, one or more brokers may operate and may derive revenue through commissions, e.g., upon trading of a UVA unit, issuance of a UVA unit, or other transactions with regard to UVA units (e.g., facilitating or negotiating a transaction with UVA units).

In some embodiments, the administrator of the electronic platform or other suitable entities may directly approach UVA owners (e.g., private owners, or galleries) and/or UVA creators (e.g., artists), in order to offer to them issuance of units corresponding to UVAs.

In some embodiments, the administrator of the electronic platform may collect an upfront commission upon issuance of UVA units. In some embodiments, the administrator of the electronic platform may collect commissions upon execution of a trade of UVA units, and/or upon receiving a trade order (e.g., a sell order, a buy order, or the like) from a user.

In some embodiments, optionally, a set or group of UVAs may be handled as a single UVA set. For example, a UVA set may include two or more UVAs (e.g., of the same type, or of multiple types, for example, a set of a painting and a sculpture).

Some embodiments may include a trading arena which may be, for example, a global or national or local platform for the purpose of units of UVAs. The trading arena may provide UVA owners and potential purchasers with the ability to trade parts (e.g., percentages or units) of UVA(s) in a substantially continuous and streamlined manner. The trading arena may offer its users a platform which facilitates trade and does not necessarily create value; the value of each UVA traded in the trading arena may be derived from market forces (e.g., supply and demand, fluctuations in art appraisals, or the like) and not from managerial efforts of the administrators of the trading arena.

In some embodiments, the UVAs may be generally passive assets. The units of UVAs, which may be traded through the trading arena, may be the title of the unit holder, and may be traded in the trading arena according to discretion of the unit holder. In some embodiments, the unit holders of a UVA may not possess any right with respect to the UVA itself, except for the right to trade their units in the trading arena.

In some embodiments, UVAs and the trading of their units may be subject to uniform rules and regulations of the trading arena; which may provide to every UVA an opportunity to be issued and traded on its electronic platform subject to predetermined criteria. This structure may allow investors an opportunity to invest in various art pieces through a potentially liquid and transparent environment.

In some embodiments, the trading arena may be associated with multiple types of users, for example, active trading players, and procedural players.

In some embodiments, the active trading players may include, for example: potential sellers (e.g., galleries, dealers, museums, art banks, hedge funds, auction houses, private collectors, artists, curators, or the like); potential purchasers (e.g., individual investors, corporate investors, corporate entities, hedge funds, art banks, galleries, dealers, auction houses, museums, curators, art aficionados, or the like); brokers (e.g., one or more brokers may act as intermediaries between purchasers and sellers); art specialists and advisors (e.g., acting as a source of information for their clients, or as actual traders); end-users (e.g., an individual or a corporate entity which accesses the electronic platform of the trading arena in order to perform a transaction, for example, to purchase UVA units, to sell UVA units, or to issue units for a UVA; typically, the end user may be an individual and not a gallery, a museum, an institution or an art dealer).

In some embodiments, the procedural players may include, for example: a system operator (e.g., an entity responsible for the financial and operational activities that are related to the trading arena; and which provides operation services, for example, activity reconciliation, commission management, listing of UVA units, and balancing); custodians (e.g., an entity able to provide storage, custody and safekeeping for UVAs whose units are traded); insurers (e.g., to insure the UVA whose units are traded); processing banks (e.g., to manage the cash and currency assets, and/or to provide banking cash-related services to the operator); and affiliates (e.g., for exhibition and/or storage purposes; optionally including galleries and museums which comply with storage and maintenance requirements set by the system operator, by the custodian and by the insurer).

In some embodiments, some UVAs, whose units are traded in the trading arena, may be exhibited to the general public or to a group of viewers who meet particular criteria, for free or for a fee; whereas other UVAs, whose units are traded in the trading arena, may not be exhibited to the general public or to anyone.

In some embodiments, a UVA may be temporarily loaned for exhibition, even though UVA units were issued and/or are traded in parallel. Although such exhibition may reduce the security or safety of the tangible UVA, such exhibition may contribute to increase the value of the UVA as well as its UVA units.

In some embodiments, the trading arena may provide each distinct player with a unique interface to facilitate its needs. The platform may be transparent and neutral to the players trading decisions; and execution of the transactions may take place upon automatic confirmation of the platform to purchase bids and selling bids that match price and quantities of UVA units. In some embodiments, the system operator may collect commissions which may be calculated, for example, as a percentage of the issuance price; as a fixed percentage of each selling and purchasing transaction; as a flat fee per transaction, or per unit; or as a combination of fee structures.

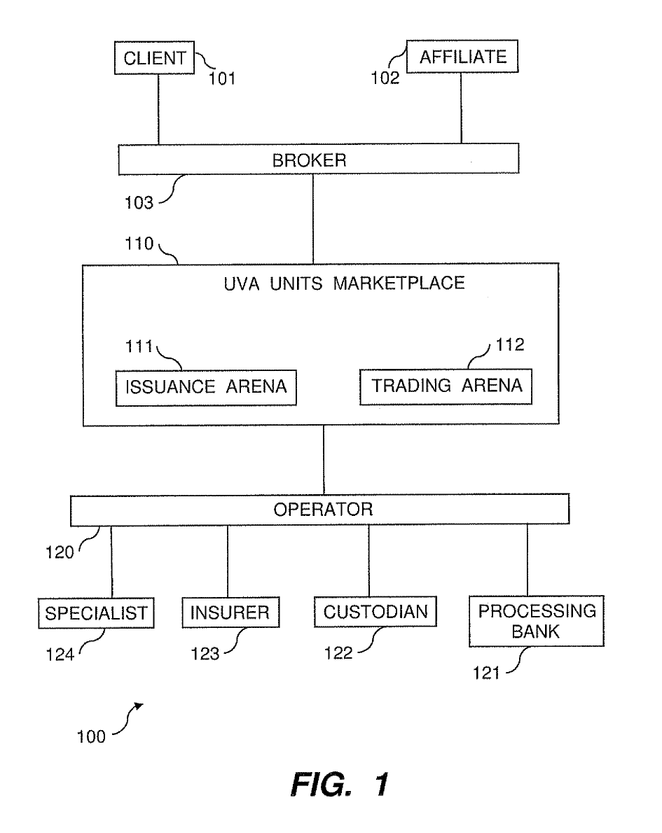

Reference is made to FIG. 1, which is a schematic block diagram illustration of a system 100 in accordance with some demonstrative embodiments.

The system may include, for example: a UVA units marketplace 110, which may optionally be divided into an issuance arena 111 (for purchasing newly-issued units of a newly-listed UVA) and a trading arena 112 (for trading previously-issued units of a previously-listed UVA); one or more clients 101 and one or more affiliates 102, which may operate using one or more brokers 103; and an operator 120 to operate the UVA units marketplace 110. The operator 120 may be associated with, for example, a processing bank 121, one or more custodians 122, one or more insurers 123, and one or more specialists 124. Other suitable entities may participate in system 100, and other suitable structures may be used for system 100.

In some embodiments, client 100 may be an end-user (e.g., an individual or a corporate entity) who desires to buy or sell UVA units through the UVA units marketplace 110. For example, client 100 may open a trading account with broker 103; client 100 may deposit funds in the account, and client 100 may receive access to an online electronic trading system which may allow him to perform trade activity within the UVA units marketplace 110. In some embodiments, a client 110 who owns a UVA may further interact with system 100 through a process of transforming the UVA from a tangible item into a plurality of nominal UVA units to be traded in the UVA units marketplace 110.

In some embodiments, an affiliate 102 may be an owner of an active website, a gallery, an art dealer, or similar entity who wishes to introduce to the UVA units marketplace 110 a cluster of clients (or a list of other affiliates 102) that will receive electronic access to the UVA unit marketplace 110.

In some embodiments, the broker 103 may be an entity able to provide services to clients 101 who approach the broker 103 either directly or indirectly through an affiliate 102. The broker 103 may provide all trade-related services, for example, account opening and maintenance, help desk and customer support, account management, or the like. In some embodiments, the broker 103 may markup services and transactional costs in order to create its own profit models. In some embodiments, the each broker 103 may open one or more omnibus accounts with the operator 120.

The UVA units marketplace 110 may include one or more arenas in which trading activities may take place with regard to UVA units. The UVA units marketplace 110 may provide rapid, accurate and fair management and operation of transactions and related information flow. The UVA units marketplace may be managed or configured by the operator 120 to, for example, implement and supervise trading rules; list newly-issued UVA units; provide market data to market participants and to other non-related entities (e.g., to the press or to the general public); manage the listed UVA units (e.g., using a catalog or a unit master file);and provide electronic access and dealing facilities to the brokers 103.

The operator 120 may be responsible for the financial and operational activities that are related to the UVA units marketplace 120 its major participants, including clients 101, affiliates 102, and brokers 103. For example, each broker 103 may open and maintain one or more accounts with the operator 120; and all the UVA unit activities and cash activities of that broker 103 and of its clients 101 may be directed to be transacted through that account. The operator 120 may provide operation services to the brokers 103, for example, execution of account opening procedures, activity reconciliation, commission management, listing of UVA units, balancing, or the like.

As discussed above, the processing bank 121 may manage all the cash and currency assets and may provide banking cash-related services to the operator 120; the custodian 122 may be responsible for safekeeping the tangible UVA whose units are traded in the UVA units marketplace 110; the insurer 123 may insure such tangible UVA; and the specialists 124 may include appraisers and other advisors to the operators 124.

The operator 120 may utilize an electronic sub-system in order to manage and administer the operation of clients 101, affiliates 102, brokers 103, the UVA units marketplace 110, balances and positions, or the like. Such sub-system may include, for example: an administration module to manage all client entities, instruments and static data; a processing module to process trade and cash transactions, to manage the UVA units inventory in real-time, and to provide clearance of commissions; a reporting module, to report activity, balances, and statistics; a monetary module to manage and operate cash and currency; an interface and matching module for interfacing the processing bank(s); an module to support affiliates 102, and a module to detect and correct errors; a module to manage the UVA units master file; or the like.

In some embodiments, each broker 103 may utilize a sub-system to provide Direct Marketplace Access (DMA) to clients 102; to allow clients 102 to perform trading activities; and to allow data delivery and presentation to clients 102 and well as analytic. In some embodiments, system 100 may offer to brokers 103 a pre-prepared broker system (e.g., using templates and configuration tools) which may be branded or co-branded or white-labeled, or which may be integrated with other trading systems.

In some embodiments, system 100 may optionally include a portal sub-system to allow capturing of new clients 101 and/or affiliates. Such sub-system may include, for example, a database of UVA information; a module for presenting UVA information; a module for searching and researching UVAs; or the like.

In some embodiments, the UVA units marketplace 110 may include modules to allow a multi-arena structure, continuous open market, issuance of UVA units, administration of a Global Unique Identifier (GUID) to each UVA, distribution of proprietary data, management of a data center, deal matching, order book management, administration of trading rules, administration of UVA units master data, or the like.

In some embodiments, system 100 may optionally include a social networking module able to present to users a virtual social network in which users may be able, for example, to discuss various UVAs, to discuss the UVA units marketplace, and to discuss various aspects or information which may be related to UVA or to trading of UVA units.

In some embodiments, system 100 may be implemented using hardware components and/or software components, for example, processors, memory units, storage units, input units (e.g., mouse and keyboard), output units (e.g., display units), communication units (e.g., transceivers or network adapters), Operating Systems, applications, or the like.

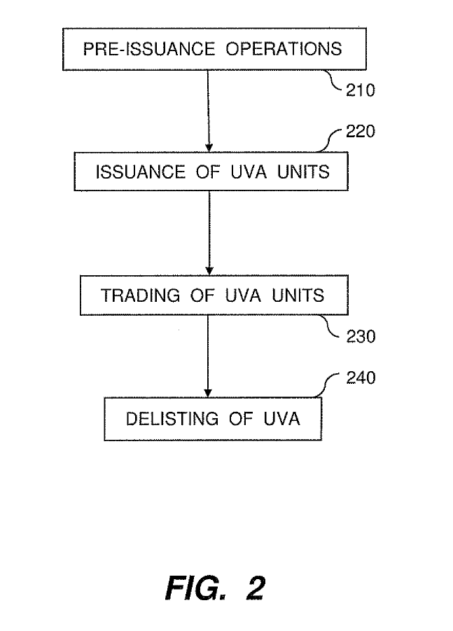

Reference is made to FIG. 2, which is a schematic flow-chart of a method of handling a UVA and trading its respective units, in accordance with some demonstrative embodiments. The method may include, for example: a pre-issuance stage 210; an issuance stage 220; a trading stage 230; and optionally, a delisting stage 240.

In the pre-issuance stage 210, any of the potential sellers described above may apply to issue a UVA on the trading arena according to a pre-defined set of rules, procedures and criteria (“Rules”), determined by the system operators, rules which may be available to the general public and/or to a particular group of persons or entities. The pre-issuance stage may include a due diligence process provided by a network of outsourced qualified advisors and specialists in the art field (“Specialists”). In some embodiments, the due diligence process may include, for example, the following examinations: (a) certification of ownership, supported by an affidavit of the owner certified by a lawyer or by a public notary; (b) verification of authentication of the UVA; (c) appraisal of the UVA. In some embodiments, only UVAs examined and approved by the Specialists that match the criteria set by the system operator—may be approved for issuance of units thereto. In some embodiments, the system operator may have no standing with respect to the UVAs approved (or rejected) for issuance. In some embodiments, the system operator may be required to provide the potential sellers with the fair opportunity to issue every UVA approved by the Specialists that match pre-defined criteria (e.g., minimum appraised value; minimum age of the UVA; or the like). In some embodiments, the issue price for units of the UVA may be determined by the Specialists, following the appraisal of the UVA; or the issue price may be determined by other calculations, and may require approval by the owner of the UVA.

In the issuance stage 220, the UVA to be issued may be transformed from a tangible asset to a nominal asset. In some embodiments, no less than 100 percent of the rights in a UVA may be registered as corresponding units to be traded. In some embodiments, the UVA offered for issuance may be presented for a limited time (e.g., as defined in the rules), by the system operator on an electronic issuance arena, together with the UVA's details including the issue price and the number of units offered for issuance. In the “issuance arena”, potential purchasers may place irrevocable binding offers to purchase unit(s) of the UVAs offered for issuance (“Acquisition Bids”).

In some embodiments, if the aggregate Acquisition Bids do not exceed the minimal qualified issuance (as defined in the Rules), then, all Acquisition Bids shall be null and void and the UVA may not be proceed to the trading stage detailed below.

In some embodiments, if the aggregate Acquisition Bids exceed the minimal qualified issuance (as defined in the Rules), the following actions may be taken: Acquisition Bids shall be processed and executed; Monies for the acquisition shall be transferred from the purchasers to the issuer; the issuer may pay the system operator its commission; each purchaser may pay to the system operator a purchase commission; the issued units of the UVA may be listed for trade on the trading arena; the UVA may be shipped or transferred to the custodian's facilities or to another safekeeping facility approved by the custodian.

In the trading stage 230, UVA unit holders may place selling bids indicating requested price and number of units for sale. Potential buyers may place acquisition bids stating the number of UVA units requested to be purchased and the offered price per UVA unit. In some embodiments, purchase bids and selling bids may be processed automatically according to criteria as set forth in the Rules. The price per UVA unit may be adjusted according to processed transactions. For example, UVA unit prices may reflect supply and supply of the units on the marketplace which shall be influenced by external market forces (e.g., trends, auction prices of art pieces of an artist, recession of the financial markets, speculations, political or environmental effects, or the like). In some embodiments, The trading platform may be transparent to the trading; and, except for pre-defined exceptions set forth in the Rules (e.g., events of unusual change in the price per unit that exceeds a percentage defined in the Rules), the system operator or the electronic platform may not intervene in the trading process; and substantially all transactions may be processed automatically according to the Rules. At this stage, the system operator may receive selling and purchasing commission from sellers and purchasers, respectively.

In an optional stage of delisting 240, acquisition or accumulation of 100 percent of the issued units of a UVA by a single entity may occur, and may optionally result in delisting of the UVA and its units from further trading. For example, an individual or entity that desires to become the sole owner of a specific UVA (“Desired UVA”) and obtain all rights with respect to the Desired UVA, including physical rights to the tangible UVA itself, may purchase and accumulate 90 percent (or other threshold percentage, e.g., 95 percent, 98 percent, 99 percent) of the issued units of the Desired UVA (“Major Unit-Holder”). The holders of the remaining 10 percent (or other remainder) of the units of the Desired UVA may be required to sell their units in the Desired UVA to the Major Unit-Holder for a price-per-unit which may be equal to the last market price, or to a price-per-unit which may otherwise be calculated (e.g., an average of recent last market prices; a premium of percentage above the last recent market price; or the like). In some embodiments, if the original owner of the Desired UVA still owns a material percentage of the units of that UVA, then, the party that desires the UVA may grant to the original owner an option to purchase all of its UVA units for a particular price; the option may be limited in time and subject to the successful accumulation of 90% of the remaining UVA units; and following the exercise of the option, the holders of the remaining 10% may be required to also sell their UVA units to that Major Unit-Holder.

In some embodiments, upon consummation of the above transactions, the Major Unit-Holder may own 100 percent of the issued units of the Desired UVA; and all the units of the UVA may be removed from the trading arena, may be delisted, and the UVA itself may be shipped or transferred as a tangible item to the Major Unit-Holder.

In some embodiments, in addition to the abovementioned mechanism for purchasing 100 percent of the issued units of a UVA, an illiquid UVAs may be defined in the Rules according to specific criteria, and may be shifted from the trading platform to a parallel auction platform to allow acquisition of the entire UVA and to allow removal of the UVA units from trade and delisting of the UVA from the trading arena.

In some embodiments, the system may allow substantially any entity of the general public to purchase units of a particular UVA (e.g., in an initial offering at the issuance of the UVA, or later in the continuous trading stage). In some embodiments, a particular UVA may be restricted such that its units may be purchased (in the initial offering at the issuance of the UVA, and/or in a subsequent trading stage) only by a particular group, for example: only by users who already own one or more units (or a threshold number of units); only by users who already own one or more units (or a threshold number of units) of UVA(s) of a particular type (e.g., paintings, as a distinct type from sculptures) or a particular sub-type (e.g., Renaissance paintings, as a distinct sub-type from Expressionism paintings) or a particular artist (e.g., Picasso, Rembrandt, or the like); to users who own unit(s) that have a current value which is greater than a threshold amount (e.g., at least one million Dollars); to users who purchased one or more units of UVA(s) within a pre-defined period of time (e.g., only users who utilize the trading platform for more than 12 months); to high-volume or high-frequency UVA unit traders (e.g., only a user who trades UVA units in a volume of at least one million Dollars per month; only a user who trades at least 30 units of UVA(s) per month); or other suitable criteria.

In some embodiments, the trading platform may provide anonymity and/or privacy to traders of UVA units, for example: by not exposing their personal details to other traders, or to one or more other entities (e.g., brokers) who utilize the system. For example, a particular user may be able to know that another user offers to sell 20 units of a particular UVA, but may not be able to know who that other user is. In other embodiments, the trading platform may disclose such information; such that, for example, a first trader may know the identity of a second trader who offers to buy or sell UVA units. In other embodiments, partial anonymity may be provided, for example, by hiding the particular identity of traders, but disclosing some information about them (e.g., country of residence). Other suitable schemes may be used with regard to privacy and/or anonymity.

In some embodiments, the system operator may utilize one or more marketing methods in order to bring to the attention of the public, or groups within the public, the existence and operation of the UVA trading arena. In some embodiments, marketing efforts may be directed at two groups of users: at Potential Sellers who may be interested in issuing their UVAs for trading in the arena; and at Potential Purchasers who may be interested in buying and trading issued units of UVAs.

In some embodiments, to attract the potential sellers, the system operator may employ direct focused marketing methods to each distinct group of sellers; and may also use word of mouth by artists, galleries, art dealers, and art collectors, as well as other suitable methods.

In some embodiments, to attract the potential purchasers, the system operator may exercise one or more of the following marketing methods: Internet marketing methods, using affiliation programs, Search Engine Optimization (SEO) and other Internet marketing techniques, which may optionally be directed to mass random end-users; focused marketing to specified art specialists, such as art dealers and galleries which may have access to a vast number of potential investors (the specialists may spread the word and advertise the trading arena and the investment opportunities on the trading arena); advertisement in art fairs; promotion by the brokers, such as private banking and major auction houses, to their clientele; affiliation program with art indexes websites, which may receive commissions for each buyer referred by such website to the trading platform and who performs a transaction on the trading arena; and other suitable methods.

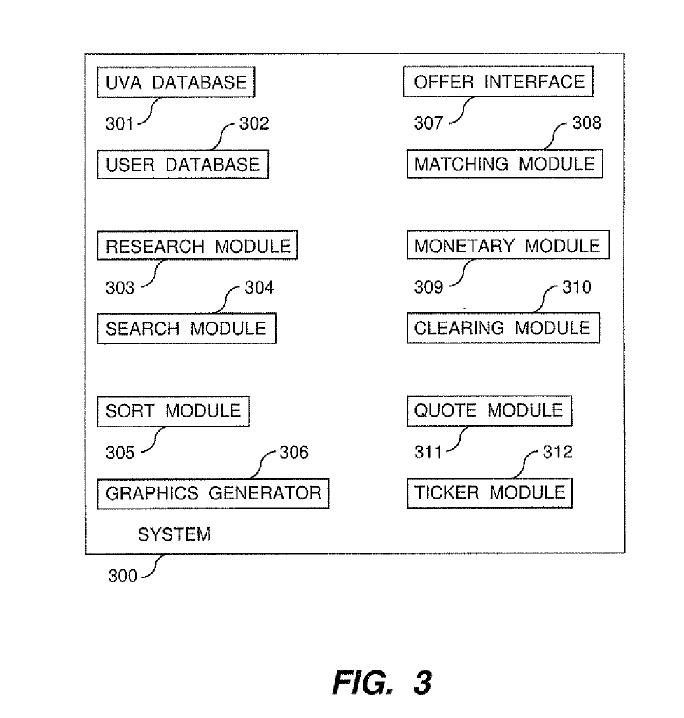

Reference is made to FIG. 3, which is a schematic block diagram illustration of a system 300 in accordance with some demonstrative embodiments. System 300 may be implemented, for example, using a combination of hardware components and/or software components; and may utilize client-server architecture or distributed architecture. In some embodiments, system 300 may be part of a trading platform for trading UVA units; may include modules residing on a central server and/or on client devices; may include modules residing on a computer of the operator of the platforms, residing on computers of brokers, and/or residing on computers of end-users; or may have other suitable configurations.

System 300 may include multiple databases which may be separate or interconnected, for example: a first database 301 storing data about UVAs (which may be denoted “UVA Database 301”); and a second database 302 storing data about users (which may be denoted “User Database 302”).

In some embodiments, each UVA be associated with a table or a record in the UVA Database 301, indicating or listing the units that were issued for that UVA, as well as indicating the current owner of each such unit (e.g., using a pointer or a reference to a user represented in the User Database 302). Optionally, the UVA Database 302 may store additional data per each UVA, and/or per each unit of each UVA, such as: the price paid and/or offered per UVA unit; previous prices that had been paid and/or offered per UVA unit; history of previous transactions and owners per UVA unit; or the like.

In some embodiments, each user may have a record in the User Database 302, which may include data indicating for example: user-identifying data (e.g., first name, last name, date-of-birth, governmental-issued identification number, or the like); username and password for accessing the service; a list of UVAs in which the user currently holds units, and the number of units currently held, and optionally the price paid per unit of each such UVA; data about currently-open offers that the user placed in order to buy or sell UVA unit(s); historical information about past transactions of the users, and optionally about past offers or bids that the user placed and were fulfilled or not fulfilled; the amount of cash that the user deposited and which is still available for purchase of UVA units; and other suitable data.

For demonstrative purpose, the UVA Database 301 may include a first table corresponding to the painting “Sunflowers” by the painter Vincent van Gogh (e.g., having a “ticker symbol” of “SUNF”); and a second table corresponding to the sculpture “The Thinker” by the sculpture Auguste Rodin (e.g., having a “ticker symbol” of “THNK”). The first table may store data indicating that, for example: (a) a total of 80 units were issued for this UVA; (b) out of these 80 units, 6 units are still available for purchase from the issuer; (c) the remaining 74 units are held by users; (d) out of the 74 units held by users, 30 units are held by user number 501, and 44 units are held by user number 602; (e) the 30 units that are held by user number 501 were purchased by that user from the issuer on Jul. 2, 2010, for a price of 108,000 USD per unit; (f) the 44 units that are held by user number 602, were purchased by that user from another user, denoted as user number 703, on Jun. 30, 2010 for a price of 106,500 USD per unit; (g) data pertaining to the UVA itself (e.g., where is the UVA physically stored, who is the custodian of that UVA, at which date were the UVA units first issued); (h) historical data about past transactions and past offers with regard to units of that UVA; and other suitable data with regard to that UVA and/or its units. The second table may include similar data with regard to the second UVA mentioned above. In some embodiments, each data for each UVA may be stored using a separate table; in other embodiments, data for each UVA may be stored as a record or as a set of records in a table; other suitable data structures may be used.

For demonstrative purpose, the User Database 302 may include 740 records or tables corresponding to 740 individuals and/or entities which utilize or utilized the trading platform. For example, the record or table for user number 602 may indicate: (a) the name (and other identifying details) of that user; (b) an indication that this user currently owns 44 units of the “Sunflowers” UVA mentioned above; (c) an indication that this user purchased these 44 units from user number 703, on Jun. 30, 2010 for a price of 106,500 USD per unit; (d) an indication of the current amount of cash that this user currently has available for further purchases (or for withdrawal); (e) historical data about past transactions and offers that the user was a party to; (f) historical information about monetary deposits and monetary withdrawal from the account of that user; and other suitable information.

System 300 may further include other suitable components and/or modules, for example: a research module 303, allowing users to research information about a particular UVA; a search module 304 allowing users to search the list of all UVAs based on free-text queries and/or by using other criteria (e.g., by type of UVA, by price-per-unit, by volume of recent trades, or the like); a sort/filter module 305 allowing users to sort and/or filter the UVA search results based on one or more criteria; and a graphics generator 306 able to generate graphical representations corresponding to UVA data, for example, a chart or a graph indicating historical prices and/or volumes traded, a pie-chart indicating unit holdings in a UVA, or the like.

System 300 may additionally include, for example: an offer interface 307 allowing users to enter offers to purchase and/or sell UVA unit(s), and to subsequently modify or cancel their pending offers; a matching module 308 able to match between offers and to establish a transaction in which the ownership in one or more UVA units moves from a first user to a second user and the monetary consideration moves from the second user to the first user; a monetary module 309 allowing users to deposit funds and/or withdraw funds from their accounts; a clearing module 310 to perform the transfer of money from a UVA unit purchaser to a UVA unit seller or issuer; a quote module 311 to generate substantially real-time price quotes for UVA units (e.g., based on a most-recent transaction, or based on a weighted average of several recent transaction); a ticker module 312 able to generate and display a scrolling ticker or a self-refreshing list of UVA unit quotes; and other suitable modules.

In some embodiments, one or more profit streams or revenue streams may be associated with issuing, trading and/or otherwise handling of UVA units. For example, the operator of the UVA units arena may receive a fee from customers of data feed(s) of UVA unit information. The operator of the UVA units arena may pay a service fee to the Fiduciary. Additionally, the operator of the UVA units arena, and/or the Fiduciary, may pay logistic fees to logistics vendors (e.g., insurer, appraiser, UVA authentication expert). Furthermore, the Fiduciary may be custodian fee or clearing fees to the custodian or clearing system(s). The operator of the UVA units arena may pay to the clearing bank fees on management operations. The operator of the UVA units arena may receive from market members (e.g., brokers) issuing fees and exchange fees; and may optionally pay them rebates on issuing and/or trading. The market members may pay to market makers (e.g., affiliates) commissions on market making activity. The market members may pay to placement agents rebates or refunds with regard to trading activity or issuing activity facilitated by such placement agents. Trading customers or dealers may pay to the market members trading fees, bidding fees for participating in the issuance stage, and a fee for takeover or tender. An owner of a UVA who wishes to securitize it may pay an issue fee to the market member. Other types of fees may be collected. In some embodiments, fees may be transferred electronically among entities in the system, automatically upon performing or requesting an operation which is associated with such fees.

Some embodiments may produce and utilize a unique financial product, which may be referred to as a “UVA Certificate” or “UVA Unit(s) Certificate” or “Art Certificate” or “Art Unit(s) Certificate” (even though UVAs are not limited to art objects). For example, the UVA Certificate may be structured as a perpetual bond or certificate, denominated with partial ownership units (e.g., percentage of ownership), having no nominal value or no par value, and may be unassociated with any particular date of maturity. Each UVA Certificate may represent a proportionate economic and beneficial interest in the UVA, and the holders or owners of UVA Certificates may rank “pari passu” without any particular order or preference among themselves.

In some embodiments, the face denomination of the UVA Certificate may represent an unchangeable percent of ownership over a physical, tangible, UVA (e.g., a unique artwork, antique item, diamond, or the like).

In some embodiments, a legal and/or operational and/or other mechanism may be used to guarantee the value preservation of UVA Certificates. For example, the mechanism may include the legal and operational relationships between a custodian and/or fiduciary, a clearing facility, a storage facility, and UVA Certificate holders. In some embodiments, the mechanism may be embodied in a contract, a prospectus, a set of legal documents or contracts, a by-laws document, or the like. Such documents may include, for example, Fiduciary Contract(s) entered into between a Settler (who is the owner of the UVA prior to issuance of UVA units) and the fiduciary entity, as well as between and the fiduciary entity and the UVA Certificate holders.

Some embodiments may include a securitization process, which transforms the underlying UVA from a tangible object into the financial product or a security. This may include the sequence of operations performed between the moment a seller (a settler) presents a UVA for securitization, until the settler receives a global UVA Certificate (e.g., the virtual form of the financial product) which may be in bearer certificate form. The process may include, for example: certification of ownership of the UVA; authentication of the UVA; appraisal of the

UVA, and determination of initial offering price; insurance of the UVA; transportation and storage of the UVA at a secure facility; preparation of a prospectus (or other legal document(s)), and issuing of the global UVA Certificate. The securitization process may be followed by the continued storage and reconciliation and identification between the physical UVA (kept in storage) to the global UVA Certificate and the UVA Certificates (traded on the trading platform for UVA units).

In some embodiments, the securitization process for a UVA which may be an artwork, e.g., a painting, may include issuance of a prospectus. The prospectus may include, for example, a photograph or the UVA; details (e.g., name, date of birth, date of death if relevant, country of residence) of the artist or creator of the UVA; name or title of the UVA; a type of the UVA (e.g., painting, sculpture); a category of the UVA within its type (e.g., impressionism, contemporary, 19th Century); instrument medium of the UVA (e.g., oil, canvas, water-paint); measurements or dimensions; creation date; creation place; background data (e.g., “from the collection of John Smith”, or a quote from the artist, or a quote from an art specialist); provenance or origin data (e.g., “UVA was acquired directly by the settler from the artist who created the UVA”, or a chain of title); and other suitable information.

In some embodiments, a pre-settling phase of the process may include, for example: certification of ownership in the UVA (e.g., by an expert); verification of authentication of the UVA and production of condition report (e.g., by an expert); optionally, a restoration process to repair or improve a property of the physical UVA (e.g., cleaning or dusting of a sculpture without damaging it; repairing a frame of a painting); or the like.

In some embodiments, the settler may set a minimum price requested for the UVA units to be issued, optionally based upon independent appraisal. In some embodiments, a UVA may have more than one public offering, for example, a first public offering of UVA units, followed later by a second public offering of UVA units); and in such case, a floor price may be set, for example, based on the current market value of the already-traded UVA units. In some embodiments, the process may define the minimum quantity (e.g., as percentage) to be issued during the auction of UVA units, based on the UVA parameters, based on the Rules set by the trading platform, and/or based on the request or requirement of the Settler. In some embodiments, a maximum quantity (e.g., as percentage) may also be similarly defined.

In some embodiments, an auction may be performed (e.g., electronically, online) among bidders to purchase UVA units offered by a settler of the UVA. The Rules of the trading platform (e.g., the issuance arena, or an Exchange) may define a bidding period, during which the auction may take place; and bid orders can be placed to the trading platform by any entity, through the market members (e.g., the brokers). The order number may specify the bid price and quantity that the participant is willing to purchase in the auction. In some embodiments, the minimum bid price may be based upon the appraisal of the UVA, and may be denoted per one UVA Certificate in a particular currency (e.g., Euro or U.S. Dollar). In some embodiments, listing of a UVA on an Exchange may be subject to placing, through an auction process, at least a minimum of a particular number of UVA Certificates representing a particular minimum percentage of all the UVA Certificates in issue (the “Minimum Participation Rate”, e.g., 75 percent, 60 percent, 51 percent, or the like).

In some embodiments, on the closing date of the bidding period, the final sale price and allocation of units will be determined according to pre-determined Rules, which may involve a multiple-step process which begins with: validation of pre-requisite condition(s), and price determination.

In some embodiments, the validation of pre-requisite condition(s) may include: before actually closing the auction process and proceeding with the price determination, the Exchange may validate whether or not the bidding reached the Minimum Participation Rate required for the auction. If the total number of bids collected during the bidding period is below the minimum participation rate, then, the auction and all bid orders may be cancelled, as the auction failed due to lack of interest, and no listing of the UVA will occur.

In some embodiments, the price determination may now take place. In other words, if the Minimum Participation Rate is reached, then the auction closing may proceed. In some embodiments, for example, the Exchange may sort the bid orders according to each bids' price (the price a bidder is willing to pay for the number of UVA Units that he requested to purchase). Then system may aggregate all of the bid orders units, until the first to reach of either (a) the total units offered in the auction, or (b) the total bid order units. The aggregation may start with the orders having the highest price going down to the lowest price. The final sale price may be set according to the price of the bid(s) which close the calculation.

Some embodiments may utilize pre-determined rules to handle an over-subscription scenario. In a demonstrative embodiment, the settler would like to offer for sale 1,000,000 UVA Units, having a minimum price of 9 Euro, with a Minimum Participation Rate set to 60 percent. In this demonstrative example, the total quantity of UVA Units ordered in the bid process is 1,255,000 UVA Units; and the participation rate is thus greater than 100 percent, namely, an over-subscription scenario.

In a demonstrative example of some embodiments, the following table, denoted Table 1, may represent seventeen purchase bids placed in an auction for UVA Certificates of a particular UVA:

TABLE 1

| Bid-Order ID | Bid Quantity | Bid Price |
|---|---|---|
| 100 | 100,000 | 9.5 |
| 101 | 50,000 | 12 |
| 102 | 110,000 | 10 |
| 103 | 80,000 | 11 |
| 104 | 90,000 | 12 |
| 105 | 20,000 | 14 |
| 106 | 150,000 | 13 |
| 107 | 55,000 | 10.5 |
| 108 | 80,000 | 13 |
| 109 | 5,000 | 13 |
| 110 | 70,000 | 12 |
| 111 | 5,000 | 10 |
| 112 | 5,000 | 13 |
| 113 | 70,000 | 9 |
| 114 | 55,000 | 9 |
| 115 | 10,000 | 9.5 |
| 116 | 300,000 | 11 |

In some embodiments, the system may sort the bid orders of Table 1 according to descending price, to produce the following table, denoted Table 2:

TABLE 2

| | | | | Quantity |
|---|---|---|---|---|
| | | | | of Units |
| Bid-Order | Bid | Bid | Aggregated | Left to be |
| ID | Quantity | Price | Quantity | Allocated |
| 105 | 20,000 | 14 | 20,000 | 1,000,000 |
| 106 | 150,000 | 13 | 170,000 | 980,000 |
| 108 | 80,000 | 13 | 250,000 | 830,000 |
| 109 | 5,000 | 13 | 255,000 | 750,000 |
| 112 | 5,000 | 13 | 260,000 | 745,000 |
| 101 | 50,000 | 12 | 310,000 | 740,000 |
| 104 | 90,000 | 12 | 400,000 | 690,000 |
| 110 | 70,000 | 12 | 470,000 | 600,000 |
| 103 | 80,000 | 11 | 550,000 | 530,000 |
| 116 | 300,000 | 11 | 850,000 | 450,000 |
| 107 | 55,000 | 10.5 | 905,000 | 150,000 |
| 102 | 110,000 | 10 | 1,015,000 | 95,000 |
| 111 | 5,000 | 10 | 1,020,000 | |
| 100 | 100,000 | 9.5 | 1,120,000 | |
| 115 | 10,000 | 9.5 | 1,130,000 | |
| 113 | 70,000 | 9 | 1,200,000 | |
| 114 | 55,000 | 9 | 1,255,000 | |

In the demonstrative example shown above, the final sale price per UVA Unit may be set to 10 Euro, since this is the price where the aggregated number of units reaches the total units offered in the auction process. Orders having a higher bid price may be fully allocated at the determined issue price. Since the auction has been over-subscribed in this scenario, orders with bid price at the determined final sale price (10 Euro) may get partially allocated since the quantity left to be allocated (95,000 UVA Units) is not sufficient to cover the quantity requested at this price (115,000 UVA Units).

In the demonstrative example shown above, the proportional allocation may be a function of the quantity left to be allocated at the determined issue price. For example, order number 105 may receive 90,870 UVA Units, calculated as (110,000/115,000)×95,000; and order number 111 may receive 4,130 UVA Units, calculated as (5,000/115,000)×95,000. Other suitable calculations may be used.

In some embodiments, the auction system may support various subscription scenarios, for example: (1) Auction is under-subscribed and below minimum participation rate required; the auction and accordingly the bids may be cancelled and no listing may occur. (2) Auction is under subscribed but still over minimum participation rate required; the auction may proceed and bids are fully allocated at the determined final sale price. (3) Auction is over-subscribed, as demonstrated above. Other suitable scenarios may be handled by the system.

In some embodiments, the Exchange may notify market members and/or the public as to the results of the auction for UVA Units. In some embodiments, the final sale price may be set as the first listing price at which UVA Certificates may be traded on the Exchange.

In some embodiments, a Fiduciary entity involved in the securitization process may be required to undertake fiduciary obligations. In some embodiments, upon transporting and storing the physical UVA in the storage facility, the UVA may be identified, numbered, and uniquely labeled vis-à-vis the Global UVA Certificate.

In some embodiments, the settler of a UVA may be responsible for all the information in the prospectus pertaining to the UVA. In some embodiments, some of the settler's obligations may be deemed fulfilled if the settler follows “best practice” or “safe harbor” operations pre-defined by the trading platform (e.g., utilization of particular experts to appraise the UVA, to authenticate it, or the like).

In some embodiments, the settler may pay for the pre-settling process (e.g., experts for authentication of the UVA forth); optionally, the Exchange or trading platform may fully or partially reimburse or cover these expenses. In some embodiments, the fiduciary entity may pay for transportation, storage, and insurance of the UVA; optionally, the Exchange or trading platform may fully or partially reimburse or cover such expenses

In some embodiments, a prospectus may be published or issued with regard to offering(s) of UVA Certificates for a UVA. The UVA Certificates may be perpetual, or may be for a pre-determined period of time (e.g., five years, ten years). The prospectus may be issued by a Fiduciary, or by a Settler, or by a combination of the Fiduciary and the Settler, or by other one or more entities which may be involved in the process of securitization of the UVA; which may be, for example, a corporate entity incorporated as a “Societe Anonyme” with limited liability in the Grand Duchy of Luxembourg and registered with the Register of Commerce and Companies in Luxembourg under a corporate number. The prospectus may be for issuance a particular number of UVA Certificates, which together represent a particular UVA. The prospectus may disclose that the UVA is valued, at least, at a particular sale price (e.g., in Euros).

In some embodiments, the prospectus may include provisions such that: the price per UVA Certificate issued on a fiduciary basis by the Fiduciary, is to be determined by the Exchange following a defined Auction process; and may be at least a minimum price per UVA Certificate.

In some embodiments, the prospectus may include provisions such that: the bidding period of the Auction may be from a first date-and-time until a second date-and-time.

In some embodiments, the prospectus may include provisions such that: the UVA Certificates are to be issued by the Fiduciary against the transfer to the Fiduciary of the physical UVA, valued at a particular value. The Fiduciary may hold the UVA in its own name, but at the sole risk and for the sole benefit and account (subject to the Terms and Conditions of the UVA Certificates) of the holders of UVA Certificates (the “UVA Certificate Holders”). In some embodiments, UVA Certificates may have a limited duration (e.g., thirty years); or may have no scheduled maturity date or no scheduled redemption date.

In some embodiments, the prospectus may include provisions such that: the UVA Certificates represent a pro rata beneficial interest in the UVA. In some embodiments, each UVA Certificate may represent a particular percentage (e.g., one percent, or three percent) of the interest in the UVA. In some embodiments, the UVA Certificate may not produce or yield any return or dividend or distribution or annuity, other than a possible increase in the value of the UVA Certificate (e.g., due to a possible increase in the price of the underlying UVA itself, due to supply and demand market forces, due to speculations and market forces, or the like). The UVA Certificates together evidence a fiduciary contract between the UVA Certificate Holders and the Fiduciary (the “Fiduciary Contract”); the Fiduciary Contract may be, for example, governed by the Luxembourg law dated 27 Jul. 2003 relating to the trust and fiduciary contracts (the “Trust and Fiduciary Contracts Law 2003”), pursuant to which the Fiduciary is only obligated to hold the UVA under specific conditions as set out in the terms and conditions of the UVA Certificates and, upon request of UVA Certificate Holder(s) holding 100 percent of all UVA Certificates, return the tangible UVA to such UVA Certificates Holders but has no payment obligations towards the UVA Certificate Holders. By purchasing UVA Certificates, the UVA Certificate Holders are deemed to have acknowledged and agreed to the terms of the Fiduciary Contract. The prospectus may disclose that investing in UVA Certificates involves certain risks; and that the reader should a “Risk Factors” chapter therein.

In some embodiments, UVA Certificates may be issued in bearer form and may be represented by a global certificate (the “Global UVA Certificate”). The Global UVA Certificate may be deposited on or about a particular date (the “Issue Date”) with a common depositary for a particular bank (“Clearing System(s)”) or with a suitable custodian, where the UVA Certificates are to be accepted for clearing. In some embodiments, delivery of the UVA Certificates may be made through the Clearing Systems against payment in immediately available funds on or about the Issue Date.

In some embodiments, the prospectus may provide that: The UVA Certificates have not been, and will not be, registered under the United States Securities Act of 1933, as amended (the “Securities Act”), or under any state securities laws and are subject to United States tax law requirements. In some embodiments, the UVA Certificates may not be offered, sold or delivered in the United States of America (including the States and the District of Columbia) and its territories and possessions, including Puerto Rico, the U.S. Virgin Islands, Guam, American Samoa, Wake Island and the Northern Mariana Islands (the “United States”) or to, or for the account or benefit of, U.S. persons (as defined in Regulation S under the Securities Act (“Regulation S”), hereinafter “U.S. Persons”), unless registered under the Securities Act or if an exemption from the registration requirements thereunder is available. In some embodiments, UVA Certificates may be offered, sold and delivered only to non-US persons in offshore transactions outside the United States in compliance with Regulation S under the Securities Act.

In some embodiments, application may be made for listing of the UVA Certificates on the UVA Exchange, a Multilateral Trading Facility (“MTF”) operated by the Operator (e.g., a Societe Anonyme established in Luxembourg). In some embodiments, suitable arrangements may be made such that an offering of UVA Certificates may be addressed to uses located in (or residents of, or citizens of) a single country, or a set of countries, or regionally (e.g., the European Union) or globally. In some embodiments, Certificates of a particular UVA may be traded only in one UVA exchange at any time; whereas in other embodiments, two or more portions of a UVA may be securitized across two or more, respective, UVA exchanges which may be located in two or more countries (e.g., in order to reach users in multiple markets).

In some embodiments, the prospectus may provide that: the prospectus constitutes a Prospectus for the purposes of Directive 2003/71/EC (the “Prospectus Directive”) and has been prepared in accordance with the Luxembourg law of 10th Jul. 2005 on prospectuses (loi du 10 Juillet 2005 relative au prospectus pour valeurs mobilières), as amended (the “ Luxembourg Prospectus Law”); and that the Prospectus has been approved and filed with the Commission de Surveillance du Secteur Financier (“CSSF”), the competent authority in Luxembourg for the purposes of the Prospectus Directive in accordance with the Luxembourg Prospectus Law and related regulations which implement the Prospectus Directive under Luxembourg law.

In some embodiments, the prospectus may provide that: the Prospectus has been produced solely for use in connection with the offer of the UVA Certificates in one or more Approved Territories; and that the Prospectus does not constitute, and may not be used for the purposes of, any offer, solicitation, exchange, sale or resale to anyone in any jurisdiction in which such offer, solicitation, exchange, sale or resale is not authorized, or to any person to whom it is unlawful to make such offer, solicitation, exchange, sale or resale. Furthermore, no reselling actions may be initiated or completed without the Fiduciary's prior written consent if such action(s) would entail a violation of the applicable rules and regulations and/or would trigger the requirement for the Fiduciary to comply with any regulatory regime.

In some embodiments, the prospectus may provide that: the distribution of this Prospectus in certain jurisdictions may be restricted and, accordingly, persons into whose possession this Prospectus comes are required to inform themselves about, and to observe, such restrictions. Prospective investors should inform themselves as to: (a) the legal requirements within their own jurisdictions for the purchase or holding of the UVA Certificates ; (b) any foreign exchange restrictions which may affect them; and (c) the income and other tax consequences which may apply in their own jurisdictions relevant to the purchase, holding, redeeming or disposal of the UVA Certificates. In some embodiments, the prospectus may optionally include restrictions on selling or reselling of UVA Certificates by the UVA Certificate Holders.

In some embodiments, the prospectus may provide that: investment in UVA Certificates is subject to certain risks; prospective investors should consider the risks associated with such an investment when reading the information contained in this Prospectus and be aware of the risk of losing such investment in its entirety for deciding to invest. In some embodiments, the risk description may include, for example, information regarding absence of revenue during the life of the UVA Certificate; the fact that the duration of holding may be perpetual or long term (e.g., twenty or thirty years); risk of absence of liquid market (e.g., not being able to sell UVA Certificates and realize the investment, at all or for a prolonged time).

In some embodiments, the prospectus may include a Responsibility Statement, which may provide, for example: the Settler is responsible for the information given in this Prospectus except for the information contained in the section about the Fiduciary. The Settler declares that, having taken all reasonable care to ensure that such is the case, the information contained in all parts of the Prospectus, except for the information contained in the section about the Fiduciary, is, to the best of its knowledge, in accordance with the facts and that it contains no omission likely to affect its import. The Fiduciary accepts responsibility for the information contained in the section about the Fiduciary within this Prospectus; but does not accept responsibility for any other information contained in this Prospectus.

In some embodiments, the Prospectus may include details about an Arranger for the issuance of the UVA Certificates; and may optionally include a Summary chapter which may summarize key provisions of the Prospectus.

In some embodiments, the Prospectus may define the relevant terms used therein, for example: Arranger; Fiduciary (e.g., the issuer of the UVA Certificate); the UVA itself; the Listing Agent; the Custodian for the UVA; the Insurer of the UVA; the Settler (e.g., the owner of the UVA having transferred the tangible UVA to the Fiduciary in exchange for the issue by the Fiduciary of all of the UVA Certificates); the number of UVA Certificates in issue; the closing date of UVA Certificates (e.g., to be determined at the end of the Auction process); Minimum Bid Price per UVA Certificate; one or more codes or securities codes or ticker symbols which may be associated with the UVA Certificates; or the like.

In some embodiments, the Prospectus may include a diagram or a text to indicate that the Settler transfers the UVA to the Fiduciary; who in turn issues and transfers UVA Certificates to holders who purchase them and hold them in accordance with the Fiduciary Contract.

In some embodiments, the Prospectus may provide about maturity and redemption of UVA Certificates; for example, that UVA Certificates have a duration of 30 years and the Fiduciary Contract evidenced thereby is to be compulsorily redeemed on a particular date (or alternatively, without a scheduled maturity date). In some embodiments, the UVA Certificates may be subject, even prior to their scheduled maturity date, to a mandatory “squeeze out” process in accordance with the terms set out in the Prospectus, or to other “call” process or option.

In some embodiments, the Prospectus may provide that: each UVA Certificate represents a proportionate economic and beneficial interest in the UVA, subject to the Terms and Conditions of the UVA Certificates. The UVA Certificates for a particular UVA rank “pari passu” without any preference among themselves.

In some embodiments, the Prospectus may provide that: a Global UVA Certificate has been issued representing the entire Issue of UVA Certificates for this UVA. In some embodiments, definitive Certificates may be issued in certain circumstances.

In some embodiments, the Prospectus may provide that: the UVA Certificates are contractual rights vis-à-vis the Fiduciary and do not represent direct rights in the tangible UVA itself. Under the Fiduciary Contract, the Fiduciary is obliged to hold the UVA for the sole account and benefit and at the sole risk of the UVA Certificate Holders subject to specific conditions as set out in the Terms and Conditions of the UVA Certificates. Each UVA Certificate represents a pro rata beneficial interest in the UVA.

In some embodiments, the Prospectus may provide for separation of assets held by the Fiduciary, for example: assets including the UVA held by the Fiduciary in its fiduciary capacity are for the benefit of the UVA Certificate Holders. They are not assets for the benefit and at the risk of the Fiduciary. Such assets are not subject to claims by general creditors of the Fiduciary. The Fiduciary may not employ such assets for any purpose other than for fulfilling its obligations under the UVA Certificates.

In some embodiments, the Prospectus may provide for Enforcement Rights, for example: the Fiduciary may only be bound to seek any such remedy if (a) it shall have been so directed either by an extraordinary resolution of the UVA Certificate Holders and (b) it shall have been indemnified by the relevant UVA Certificate Holders to its reasonable satisfaction. The UVA Certificate Holders may not (except if they represent 100 percent of all the UVA Certificates in issue for that UVA) terminate the Fiduciary Contract and may not require return of the UVA from the Fiduciary.

In some embodiments, the Prospectus may include provisions about notices to UVA Certificate Holders, for example, particular notices or published notices. The Prospectus may include provisions about jurisdiction and governing law; and an indication that an application is to be made so that the UVA Certificates may be listed on the Exchange or suitable MTF.

In some embodiments, the Prospectus may disclose possible Risk Factors for purchasers or holders of UVA Certificates, for example: risk factors regarding the UVA Certificates; a risk that the UVA Certificates are not direct payment obligations of the Fiduciary; a risk that there will be no remuneration on the UVA Certificates; a risk because the UVA Certificates have no scheduled maturity date or pre-defined redemption value; a risk because the UVA Certificates participate indirectly in any change in value of tangible UVA, including losses in value; a risk because the UVA Certificate Holders have only limited recourse against the Fiduciary; a risk because an active trading market for the UVA Certificates may not develop or may not allow liquidity to investors; a risk because investors in UVA Certificates may be exposed to risks associated with the art market generally or to the general market of the UVA type; a future change of law may affect the rights of the UVA Certificate Holders; potential investors in UVA Certificates should consult their tax advisors in respect of potential tax risks of any investment in UVA Certificates; a risk because the Global UVA Certificates are held by, or on behalf of, the Clearing Systems, and thus investors may need to rely on the procedures of these institutions for transfer, payment and communication with the Fiduciary; a risk due to “squeeze-out provisions”; Risk Factors regarding the UVA itself; Risk Factors regarding the Fiduciary; a risk that the Fiduciary may not act as note trustee on behalf of the UVA Certificate Holders, or may breach his duties; a risk since the UVA Certificate Holders have only limited recourse against the Fiduciary; a risk due to substitution of the Fiduciary; and/or other risk factors.

In some embodiments, the Prospectus may provide with regard to UVA Certificates, their structure and their functions. For example, the Fiduciary has issued the UVA Certificates, against the transfer of a particular UVA having an estimated value of a particular monetary amount; and the UVA is held solely at the risk and for the benefit of the UVA Certificate Holders. The Terms and Conditions of the UVA Certificates may be incorporated (verbatim, or by reference) into the UVA Global Certificate and may be endorsed on each UVA Certificate in definitive form. By subscribing to or otherwise acquiring UVA Certificates, the UVA Certificate Holders are deemed to have knowledge of all the provisions relating to the UVA and the Fiduciary Contract, including the terms and conditions of the UVA Certificates and to expressly accept such provisions. Such provisions may include, for example: (1) The fiduciary, limited duration or perpetual, UVA Certificates with a particular Euro (or other currency) denomination each (the “Nominal Amount”) are issued on or about a particular Issue Date by the Fiduciary on a fiduciary basis. (2) The UVA Certificates together evidence the existence of a Fiduciary Contract between the Holders of the UVA Certificates and the Fiduciary; under the Fiduciary Contract, the Fiduciary has limited obligations. (3) The Fiduciary has issued the UVA Certificates against transfer to the Fiduciary of the UVA on a fiduciary basis for the sole risk and exclusive benefit of the UVA Certificate Holders. (4) Each UVA Certificate represents a proportionate economic and beneficial interest in the UVA subject to these Conditions. The UVA Certificates (which may be also called Participation Capital Certificates) rank “pari passu” without any preference among themselves. (5) The rights of the Fiduciary over the UVA are fiduciary assets of the Fiduciary, and shall be held solely at the risk and for the exclusive benefit and for the account of the UVA Certificate Holders. (6) The Fiduciary shall keep the UVA and its respective rights arising thereunder separate from its own assets, and shall duly highlight this separation in its books and accounts. The Fiduciary shall ensure that any third party with whom the UVA is on deposit (or on loan) recognizes the fiduciary capacity of the Fiduciary as owner of the UVA. (7) Each UVA Certificate may be subject to these Conditions.

Furthermore, with regard to the Fiduciary, the UVA Certificates may include the following provisions: (1) The sole purpose of issuing the UVA Certificates is to provide funds for the Fiduciary to acquire the UVA. (2) The Fiduciary shall not have any obligations to UVA Certificate Holders other than those expressly assumed by it pursuant to the Fiduciary Contract. (3) The Fiduciary has committed to keep the UVA in custody and insure it under specific conditions; to transfer ownership of the UVA to the person or entity who presents 100 percent of the UVA Certificates as set out in the Terms and Conditions of the UVA Certificates; to transfer the UVA to another fiduciary if the Fiduciary is requested to do so by a per-defined percentage (e.g., 51 percent, or 67 percent, or 75 percent) of the UVA Certificate Holders; in case the Fiduciary still possesses the UVA at the end of the contract, to transfer the UVA to new fiduciary indicated by a pre-defined percentage of the UVA Certificate Holders or, otherwise, to a new fiduciary chosen by the Fiduciary. (3) The Fiduciary makes no representation and assumes no responsibility or liability with regard to the UVA, and in particular regarding the authenticity and/or value of the UVA. (4) By purchasing the UVA Certificates, the UVA Certificate Holders are deemed to have acknowledged and agreed to the description and characteristics of the UVA. (5) Without prejudice to the right of the Fiduciary to be indemnified out of the fiduciary assets, no commission or other remuneration will be due from the UVA Certificate Holders to the Fiduciary for the performance of its services. (6) Pursuant to an appointment agreement between the Fiduciary and Settler, the Fiduciary may receive reimbursement of costs, indemnification and remuneration by the Settler and will have no obligation to account to the UVA Certificate Holders in respect thereof. (7) The liability of the Fiduciary in respect of the UVA Certificates and its role thereunder may be limited to its willful misconduct or gross negligence; furthermore the Fiduciary may not be liable for indirect damage or consequential damage of any kind (including lost profits), regardless of whether or not such indirect damage or consequential damage was foreseeable; and such limitation of liability may apply to all claims, regardless of their nature or legal basis.

Furthermore, with regard to the form and transferability of UVA Certificates, the following provisions may be used: (1) The UVA Certificates are represented by a permanent global security which may be in bearer form (the “Global UVA Certificate”). The Global Certificate shall only be valid if it bears the handwritten signature of a duly authorized representative of the Fiduciary. The Global Certificate shall be deposited with a particular entity as common depositary for the Clearing Systems. (2) For as long as the UVA Certificates are represented by the Global Certificate, beneficial interests in the Global Certificate will be shown on, and transfers thereof will be effected in accordance with the rules of the relevant Clearing System. (3) Beneficial interests in the Global Certificate may be exchangeable for definitive UVA Certificates (e.g., without coupons or talons), issued in particular monetary amounts (e.g., of Euro or other currency) each, only if the Clearing Systems or any Alternative Clearing System on behalf of which the UVA Certificates may be held notify the Fiduciary that they are no longer willing or able to discharge properly their responsibilities with respect to the UVA Certificates, or cease to be a “clearing agency” or is at any time no longer eligible to act as such and no qualified successor is appointed within 90 days of receiving notice of such ineligibility on the part of the Clearing System (or, as the case may be, such Alternative Clearing System) or is closed for business for a continuous period of 14 days (other than by reason of holiday, statutory or otherwise) or announces its intention permanently to cease business or in fact does so. In any such circumstances, a Definitive Certificate may be issued to each UVA Certificate Holder in respect of its holdings of definitive UVA Certificates, which Definitive Certificate may evidence definitive UVA Certificates with an aggregate principal amount of a particular monetary value (e.g., 100,000 Euro) or an integer multiple thereof. Each Definitive Certificate may have an identifying number, which may be recorded on the relevant Definitive Certificate. Each holder of definitive UVA Certificate may be entitled to receive only one Definitive Certificate in respect of its entire holding of UVA Certificates. A notice of the issue of definitive UVA Certificates may be notified to the UVA Certificate Holders as soon as practicable thereafter by publication in accordance with these Terms and Conditions. The costs for the issuance of Definitive UVA Certificates may be borne by the Holder, or by the Settler, or out of the fiduciary assets. In the event of absence of sufficient fiduciary assets to cover the costs of issuance of Definitive UVA Certificates, the Fiduciary may refuse to issue Definitive UVA Certificates. (4) By acquisition of a beneficial interest in a Global Certificate, any purchaser thereof will be deemed to represent and warrant that (a) it is not a United States person or a U.S. Person and is purchasing such beneficial interest for its own account and not for the account or benefit of a United States person or a U.S. person and (b) if in the future it decides to transfer such beneficial interest, it will transfer such interest only to a person that is not a U.S. person in an offshore transaction in accordance with Regulation S. In some embodiments, arrangements may be made such that securitization of UVAs into UVA Certificates may take place in the United States, or such that UVA Certificates may be offered and/or issued and/or traded in the United States, or to U.S. persons, or to U.S. citizens, or to U.S. residents. In some embodiments, arrangements may be made such that securitization of UVAs into UVA Certificates may take place in one or more other countries, or such that UVA Certificates may be offered and/or issued and/or traded in other countries, or to citizens or residents of other countries.

In some embodiments, the Prospectus may include provisions with regard to: “squeeze-out of UVA Certificates”; maturity, or compulsory redemption; taxation; resignation and substitution (e.g., of the Fiduciary); meetings of UVA Certificate Holders; modification or increases; notices; prescription; governing law; jurisdiction; dispute resolution mechanisms and forums; or the like.

In some embodiments, the Fiduciary may be incorporated; and each UVA Certificate is one of a series of the UVA Certificates issued on a fiduciary basis for a particular UVA. The UVA Certificates together evidence the existence of the Fiduciary Contract on the terms described in the Terms and Conditions of the UVA Certificates between the UVA Certificate Holders and the Fiduciary dated the Issue Date, pursuant to which the Fiduciary's sole obligation is to account to the UVA Certificate Holders for its obligations in respect of the UVA. The UVA Certificate Holder, by subscribing to and accepting any UVA Certificate, has agreed to, and is deemed to have expressly acknowledged and accepted all the provisions of the Fiduciary Contract applicable to it including the Terms and Conditions of the UVA Certificates. With the proceeds from the issue of the UVA Certificates, the Fiduciary has acquired, or will acquire, in its own name but at the sole risk and for the sole benefit of the Certificate Holders, the UVA.

In some embodiments, the Fiduciary holds the UVA on a fiduciary basis in its own name, but solely at the risk and for the account and benefit of the UVA Certificate Holders The Fiduciary Contract may be, for example, a “contrat fiduciaire” governed by the Luxembourg Law of 27 Jul. 2003 on the trust and fiduciary contracts (the “Trust and Fiduciary Contracts Law 2003”). Each of the UVA Certificate Holders, by accepting UVA Certificates has agreed to all the provisions of the Fiduciary Contract applicable to it. The Terms and Conditions of the UVA Certificates form part of the Fiduciary Contract. They set out the rights of the UVA Certificate Holders under the Fiduciary Contract and certain duties, rights, powers and discretions of the Fiduciary. The Terms and Conditions of the UVA Certificates include summaries of, and are subject to, the detailed provisions of, and definitions in, the Agency Agreement with the benefit of which the UVA Certificates are issued. As a fiduciary under a Luxembourg law-governed “contrat fiduciaire”, the Fiduciary does not and cannot represent the UVA Certificate Holders. The Fiduciary is under no obligation to the UVA Certificate Holders other than that of faithful performance of its undertakings, duties, rights and powers under the Fiduciary Contract.

In some embodiments, pursuant to the Trust and Fiduciary Contracts Law 2003, the fiduciary assets are segregated from all other assets of the Fiduciary (including from all other fiduciary assets it may hold under fiduciary contracts with third parties) and are not available to meet the claims of creditors of the Fiduciary other than creditors (including UVA Certificate Holders in their capacity as such) whose rights derive from the fiduciary assets. In a liquidation of the Fiduciary, pursuant to the Trust and Fiduciary Contracts Law 2003, the fiduciary assets may only be attached by persons whose rights exist as a result of the creation and existence of the fiduciary assets. The Fiduciary will, as legal owner of the UVA, have the benefit of its rights to the UVA and will hold the UVA as fiduciary assets for the exclusive benefit of the UVA Certificate Holders.

In some embodiments, the Fiduciary may commit, for example: to keep the UVA in custody and insure it under specific conditions; to transfer ownership of the UVA to the person who presents 100 percent of the UVA Certificates as set out in the Terms and Conditions of the UVA Certificates; to transfer the UVA to another fiduciary if the Fiduciary is requested to do so by a pre-defined percentage of the UVA Certificates Holders; and, in case it still possesses the UVA at the end of the contract, to transfer the UVA to a new fiduciary indicated by a pre-defined percentage of Certificates Holders or, otherwise, to a new fiduciary chosen by the Fiduciary. The Fiduciary makes no representation and assumes no responsibility or liability with regard to the UVA, and in particular regarding the authenticity and/or value thereof.

In some embodiments, the Fiduciary may be entitled, for example: to receive a remuneration for its services; to transfer the fiduciary estate to another fiduciary, either with the consent of a pre-defined percentage of the UVA Certificates Holders or, failing to obtain such consent, with the approval of a competent court; to receive information about the UVA.

In some embodiments, the prospectus may provide with regard to Auction and Sale of UVA Certificates. For example, with regard to admission to trading and dealing arrangements, the Listing Agent may make an application to the MTF to seek admission to trading of the UVA Certificates as and when such UVA Certificates are sold under the terms of the Auction. The prospectus may provide that at the date of the prospectus, it is not intended that similar applications will be made to other regulated markets (or equivalent markets). The prospectus may provide that the earliest date(s) on which the UVA Certificates will be admitted to trading is expected to be the Closing Date, however, prospective investors should be aware that this may be subject to approval or changes. A listing Agent may be appointed for the UVA Certificates; and the prospectus may disclose the estimated expenses for the admission to trading of the UVA Certificates. Optionally, selling or re-selling restrictions may be provided.

In some embodiments, for so long as the UVA Certificates remain outstanding, copies of the relevant legal documents may be available upon request (optionally, for a fee) at one or more business places or online.

In some embodiments, once an Initial Public Offering (IPO) of UVA Certificate took place, no further public offerings of UVA Certificates may be allowed for that UVA, and no secondary or subsequent offerings may be performed; this may allow, for example, prevention of dilution of UVA Certificate Holders. In other embodiments, subsequent public offerings of UVA Certificates may be allowed and may be performed.

Although portions of the discussion herein may relate, for demonstrative purposes, to Luxembourg laws and/or entities, these are presented only as an example; and some embodiments may be implemented in accordance with laws of other jurisdictions, and/or by utilizing entities incorporated in, or operating under, laws of other jurisdictions.

Some embodiments may include, for example, a method as described herein; a system as described herein; a computer-readable medium or storage-article able to perform the method or portions thereof; a security produce, a securities product, a fiduciary product, a set of contracts, a set of legal documents, an investment product, an Exchange product, a financial product, a contractual product, a product in bear form, a virtual product, a Certificate type product, a trade-able certificate or product, an endorse-able certificate or product, or other suitable products.

In some embodiments, optionally, the term “UVA” (even when used in singular form) may include a batch of multiple UVAs, a group of multiple UVAs, a set of multiple UVAs, or a collection of multiple UVAs. For example, a batch of two or more UVAs, which may have or may not have a common characteristic, may be treated as a singular UVA for securitization purposes, thereby allowing to issue and trade UVA Certificates such that each UVA Certificate relates to a UVA which comprises multiple UVA items. In some embodiments, for example, a batch of three paintings of the painter Picasso may be treated together as a single UVA for all purposes, including for securitization purposes. In some embodiments, for example, a set of four paintings of various Renaissance painters may be treated together as a single UVA for all purposes, including for securitization purposes. In some embodiments, for example, a group of five sculptures of one or more artists, which all depict a naked male, may be treated together as a single UVA for all purposes, including for securitization purposes. For example, the collection or batch or set or group of UVAs may be appraised as an entire batch, may be insured as an entire batch, may be subject to a common custody, and may be subject to a common fiduciary contract and securitization process as a single batch. Optionally, the ticker symbol or unique identifier of a UVA may indicate, using a particular prefix or suffix or other indication, whether a UVA comprises a single tangible item or multiple tangible items.

In some embodiment, each UVA which undergoes securitization (namely, for which UVA Certificates are issued or are offered to be issued) may be associated with a unique identifier or symbol or ticker symbol, which may be or may include a reference which uniquely identifies each UVA in the marketplace. In some embodiments for example, the unique identifier may be a string of characters (e.g., alpha-numeric characters), having a total length of twenty (or less) characters. In some embodiments, a first portion of the unique identifier (e.g., the first four characters) of a UVA may include data representing the artist who created the UVA (e.g., the prefix “PICA” indicating the painter Picasso in the UVA unique identifier of “PICA123456789”; whereas a second portion of the UVA may include data representing other properties of the particular UVA and/or a unique numeral associated with the UVA (e.g. a unique serial number). In some embodiments, optionally, one or more characters of the UVA unique identifier may indicate a type of the UVA, a creation year of the UVA, a code referring to a country associated with the artist who created the UVA, a checksum or parity check or validity character, or the like. Other suitable codes may be used. In some embodiments, a user may be able to search for, and retrieve, data about a particular UVA by entering the UVA unique identifier of that UVA.

In some embodiments, an owner of a UVA (e.g., a Settler) may be able to securitize its entire 100 percent interest in its UVA while offering to the public to purchase only a portion (e.g., only 60 percent) of the issued UVA Certificates. This may allow an owner of a UVA to only partially liquefy or liquidate its UVA, a result which may not be easily achievable in conventional sales of tangible UVAs. For example, an entity which owns a Picasso painting valued at 20 million Euro, who would like to receive 5 million Euro but to still maintain a substantial interest in that UVA, may select to securitize that particular UVA, and to offer to the public only 25 percent of the issued UVA Certificates, while retaining ownership in the remaining 75 percent of the issued UVA Certificates. This mechanism may allow a UVA owner to efficiently receive monetary equivalent for only a portion of its interest in the UVA.

Some embodiments may include writing and/or exercising of options, or of derivatives, with regard to UVAs. For example, an owner of a UVA (e.g., a settler) may securitize its rights in the UVA; may offer to the public 50 percent of the issued UVA Certificates; and may further write, for example, Call options which allow the holder of each UVA Certificate to “call” from the settler one more UVA Certificate, within a pre-defined period of time (e.g. within 12 months, or 30 months), in consideration for a pre-defined price or price range (e.g., the same price at which the UVA Certificate was purchased; or that price multiplied by a number greater than one; or that price multiplied by a number between zero and one; or an exercise price calculated as a function of prices over a pre-defined period of time). In some embodiments, the system may support writing, exercising and/or trading of such options, Call options, Put options, and other suitable securities or derivatives. In some embodiments, optionally, the system may support trading of UVA Certificates at a margin, selling of UVA Certificates from a “short” position, or other suitable transactions.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device (e.g., BlackBerry (®), Palm (®) Treo (™)), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (®), Global Positioning System (GPS), IEEE 802.11 (“Wi-Fi”), IEEE 802.16 (“Wi-Max”), ZigBee (™), Ultra-Wideband (UWB), Global System for Mobile communication (GSM), 2G, 2.5G, 3G, Third Generation Partnership Project (3GPP), 3GPP Long Term Evolution (LTE), 3.5G, or the like. Some embodiments may be used in conjunction with various other devices, systems and/or networks.

The terms “wireless device”, “wireless computing device”, “mobile device” or “mobile computing device” as used herein include, for example, a device capable of wireless communication, a communication device or communication station capable of wireless communication, a desktop computer capable of wireless communication, a mobile phone, a cellular phone, a laptop or notebook computer capable of wireless communication, a PDA capable of wireless communication, a handheld device capable of wireless communication, a portable or non-portable device capable of wireless communication, or the like.

The terms “social network”, “virtual social network”, or “VSN” as used herein include, for example, a virtual community; an online community; a community or assembly of online representations corresponding to users of computing devices; a community or assembly of virtual representations corresponding to users of computing devices; a community or assembly of virtual entities (e.g., avatars, usernames, nicknames, or the like) corresponding to users of computing devices; a web-site or a set of web-pages or web-based applications that correspond to a virtual community; a set or assembly of user pages, personal pages, and/or user profiles; web-sites or services similar to “Facebook”, “MySpace”, “LinkedIn”, or the like.

In some embodiments, a virtual social network includes at least two users; in other embodiments, a virtual social network includes at least three users. In some embodiments, a virtual social network includes at least one “one-to-many” communication channels or links. In some embodiments, a virtual social network includes at least one communication channel or link that is not a point-to-point communication channel or link. In some embodiments, a virtual social network includes at least one communication channel or link that is not a “one-to-one” communication channel or link.

The terms “social network services” or “virtual social network services” as used herein include, for example, one or more services which may be provided to members or users of a social network, e.g., through the Internet, through wired or wireless communication, through electronic devices, through wireless devices, through a web-site, through a stand-alone application, through a web browser application, or the like. In some embodiments, social network services may include, for example, online chat activities; textual chat; voice chat; video chat; Instant Messaging (IM); non-instant messaging (e.g., in which messages are accumulated into an “inbox” of a recipient user); sharing of photographs and videos; file sharing; writing into a “blog” or forum system; reading from a “blog” or forum system; discussion groups; electronic mail (email); folksonomy activities (e.g., tagging, collaborative tagging, social classification, social tagging, social indexing); forums; message boards; or the like.

The terms “web” or “Web” as used herein includes, for example, the World Wide Web; a global communication system of interlinked and/or hypertext documents, files, web-sites and/or web-pages accessible through the Internet or through a global communication network; including text, images, videos, multimedia components, hyperlinks, or other content.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A method for securitizing a Unique Valuable Asset (UVA), the method comprising:
transferring custody and ownership in the UVA from a settling owner of the UVA to a fiduciary entity;
issuing by the fiduciary entity a plurality of tradable UVA certificates which correspond to portions of ownership rights in the UVA;
electronically selling by the fiduciary entity one or more of the tradable UVA certificates, through an auction, to one or more purchasers; and
transferring from the fiduciary entity to the settling owner at least some of monetary consideration received by the fiduciary entity from said one or more purchasers of tradable UVA certificates.

2. The method of claim 1, comprising:
receiving from a first user a sale order offering to sell a first number of the tradable UVA certificates owned by the first user, for a particular asking price per UVA certificate.

3. The method of claim 2, comprising:
receiving from a second user a purchase order offering to purchase a particular number of the tradable UVA certificates, for a particular bidding price per UVA certificate.

4. The method of claim 3, comprising:
if (a) the first number of tradable UVA certificates offered to be sold by the first user is greater than or equal to the second number of tradable UVA certificates offered to be purchased by the second user, and (b) the asking price per UVA certificate is smaller than or equal to the bidding price per UVA certificate, then:
transferring ownership in the first number of tradable UVA certificates from the first user to the second user;
transferring from the second user to the first user a monetary equivalent of: the first number of tradable UVA certificates multiplied by the bidding price per UVA certificate.

5. The method of claim 4, comprising:
hiding from the first user the identity of the second user; and
hiding from the second user the identity of the first user.

6. The method of claim 1, comprising:
determining a current price-quote for the tradable UVA certificates corresponding to said UVA.

7. The method of claim 6, comprising:
generating a self-refreshing electronic display of said price-quote of the tradable UVA certificates corresponding to said UVA.

8. The method of claim 1, comprising:
prior to issuing said tradable units, transferring said UVA to custody at a custodian on behalf of the fiduciary entity.

9. The method of claim 1, comprising:
if all the tradable UVA certificates corresponding to said UVA are held by a single entity, then: (a) delisting the tradable UVA certificates from further trading; (b) terminating fiduciary duties of the fiduciary entity; and (c) transferring ownership and custody in said UVA to said single entity.

10. The method of claim 1, wherein said UVA comprises an asset selected from the group consisting of: a painting, a sculpture, a photograph, an artwork, a diamond, a jewel.

11. A system for securitizing a Unique Valuable Asset (UVA), the system comprising:
means for transferring custody and ownership in the UVA from a settling owner of the UVA to a fiduciary entity;
means for issuing by the fiduciary entity a plurality of tradable UVA certificates which correspond to portions of ownership rights in the UVA;
means for electronically selling by the fiduciary entity one or more of the tradable UVA certificates, through an auction, to one or more purchasers; and
means for transferring from the fiduciary entity to the settling owner at least some of monetary consideration received by the fiduciary entity from said one or more purchasers of tradable UVA certificates.

12. The system of claim 11, comprising:
Means for receiving from a first user a sale order offering to sell a first number of the tradable UVA certificates owned by the first user, for a particular asking price per UVA certificate.

13. The system of claim 12, comprising:
means for receiving from a second user a purchase order offering to purchase a particular number of the tradable UVA certificates, for a particular bidding price per UVA certificate.

14. The system of claim 13, comprising:
means to check if (a) the first number of tradable UVA certificates offered to be sold by the first user is greater than or equal to the second number of tradable UVA certificates offered to be purchased by the second user, and (b) the asking price per UVA certificate is smaller than or equal to the bidding price per UVA certificate, and if the check result is positive, then:
means for transferring ownership in the first number of tradable UVA certificates from the first user to the second user;
means for transferring from the second user to the first user a monetary equivalent of: the first number of tradable UVA certificates multiplied by the bidding price per UVA certificate.

15. The system of claim 14, comprising:
means for hiding from the first user the identity of the second user; and
means for hiding from the second user the identity of the first user.

16. The system of claim 11, comprising:
means for determining a current price-quote for the tradable UVA certificates corresponding to said UVA.

17. The system of claim 16, comprising:
means for generating a self-refreshing electronic display of said price-quote of the tradable UVA certificates corresponding to said UVA.

18. The system of claim 11, comprising:
means for, prior to issuing said tradable units, transferring said UVA to custody at a custodian on behalf of the fiduciary entity.

19. The system of claim 11, comprising:
means to check if all the tradable UVA certificates corresponding to said UVA are held by a single entity,
and if the check result is positive, then: (a) means for delisting the tradable UVA certificates from further trading; (b) means for terminating fiduciary duties of the fiduciary entity; and
(c) means for transferring ownership and custody in said UVA to said single entity.

20. The system of claim 11, wherein said UVA comprises an asset selected from the group consisting of: a painting, a sculpture, a photograph, an artwork, a diamond, a jewel.
